(19) United States
(12) Patent Application Publication
(10) Pub. No.: US 2019/0064350 A1
(43) Pub. Date: Feb. 28, 2019

(54) ULTRASONIC APPARATUS

(71) Applicant: CANON KABUSHIKI KAISHA, Tokyo (JP)

(72) Inventor: Takeshi Suwa, Tokyo (JP)

(21) Appl. No.: 16/111,069

(22) Filed: Aug. 23, 2018

(30) Foreign Application Priority Data
Aug. 30, 2017 (JP) 2017-165124

(51) Int. Cl. G01S 15/89; G01S 7/52

(52) U.S. Cl. CPC G01S 15/8965; G01S 7/52025; G01S 7/52077; G01S 7/52085

(57) ABSTRACT

An ultrasonic apparatus includes an ultrasonic reception unit configured to receive an ultrasonic wave generated from a subject and output a reception signal, an amplifier configured to amplify an intensity of the reception signal, a transmission unit configured to transmit an amplification signal obtained by amplifying the reception signal, an attenuator configured to output an attenuation signal obtained by attenuating an intensity of the transmitted amplification signal, and an acquisition unit configured to acquire information regarding the subject at least based on the attenuation signal.

### BACKGROUND

### Field of the Disclosure

The present disclosure relates to an ultrasonic apparatus.

### Description of the Related Art

An optical imaging apparatus for irradiating a living body with light from a light source such as a laser and generating an image of information about the inside of the living body obtained based on the irradiation light is actively studied in the medical field.

As one of optical imaging techniques, there is photoacoustic tomography (PAT). In PAT, a living body is irradiated with pulsed light generated from a light source, and an acoustic wave generated from living tissue absorbing the energy of the pulsed light propagated and diffused in the living body is detected. That is, using the difference in the absorption rate of light energy between a subject part such as tumor and tissue other than the subject part, a reception element receives an elastic wave, i.e., a photoacoustic wave, which is generated when the subject part instantaneously expands by absorbing light energy with which the subject part is irradiated. This detection signal is subjected to an analysis process, whereby it is possible to obtain an optical characteristic distribution, particularly a light energy absorption density distribution, in the living body. These pieces of information can also be used to quantitatively measure a particular substance in a subject, such as glucose or hemoglobin included in blood. As a result, the pieces of information can be used to specify the place where malignant tumor involving the growth of new blood vessels is present.

Japanese Patent Application Laid-Open No. 2016-97165 discusses a subject information acquisition apparatus using a handheld probe.

The technique discussed in Japanese Patent Application Laid-Open No. 2016-97165 has the following problem. The apparatus main body and the probe are provided in separate housings. Thus, the apparatus main body and the probe are connected by a transmission unit. A signal transmitted from the transmission unit, however, includes noise under the influence of an electromagnetic wave generated from an electronic device provided outside the transmission unit. As a result, the signal-to-noise ratio (SNR) of an output signal from the probe becomes small, and the measurement accuracy decreases.

### SUMMARY

In view of the above discussion, the present disclosure is directed to providing an ultrasonic apparatus capable of reducing the influence of an electromagnetic wave generated from an electronic device provided outside a transmission unit and acquiring highly accurate subject information.

According to an aspect of the present invention, an ultrasonic apparatus includes an ultrasonic reception unit configured to receive an ultrasonic wave generated from a subject and output a reception signal, an amplifier configured to amplify an intensity of the reception signal, a transmission unit configured to transmit an amplification signal obtained by amplifying the reception signal, an attenuator configured to output an attenuation signal obtained by attenuating an intensity of the transmitted amplification signal, and an acquisition unit configured to acquire information regarding the subject at least based on the attenuation signal.

According to another aspect of the present invention, an information acquisition method includes irradiating a subject with light, receiving an ultrasonic wave generated by irradiating the subject with the light, and outputting a reception signal, amplifying an intensity of the reception signal, transmitting an amplification signal obtained by amplifying the reception signal, attenuating the transmitted amplification signal and outputting an attenuation signal, and acquiring information regarding the subject at least based on the attenuation signal.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an ultrasonic apparatus according to a first exemplary embodiment of the present invention.

FIGS. 2A and 2B are diagrams illustrating an example of a configuration of an ultrasonic reception unit in the ultrasonic apparatus according to the first exemplary embodiment of the present invention.

FIG. 3 is a diagram illustrating a driving principle of a capacitive transducer in the ultrasonic apparatus according to the first exemplary embodiment of the present invention.

FIG. 4 is a flowchart illustrating an example of a measurement sequence for acquiring information about a subject, using the ultrasonic apparatus according to the first exemplary embodiment of the present invention.

FIG. 5 is a diagram illustrating an example of a configuration of an ultrasonic apparatus according to a second exemplary embodiment of the present invention.

### DESCRIPTION OF THE EMBODIMENTS

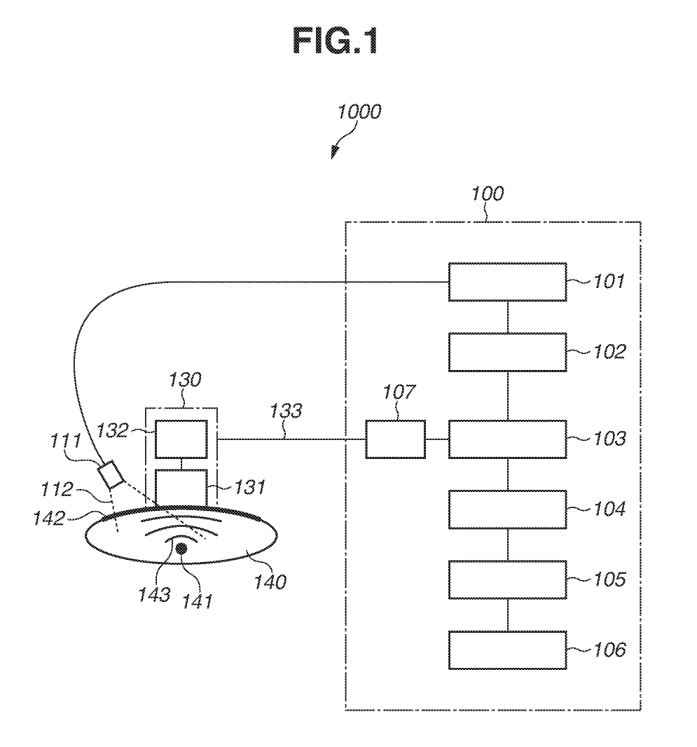

With reference to FIG. 1, an ultrasonic apparatus according to exemplary embodiments of the present invention is described.

An ultrasonic apparatus 1000 according to the present exemplary embodiments includes an ultrasonic reception unit 131, which receives an ultrasonic wave 143 generated from a subject 140 and outputs a reception signal, an amplifier 132, which amplifies the intensity of the reception signal, and a transmission unit 133, which transmits an amplification signal obtained by amplifying the reception signal. Further, the ultrasonic apparatus 1000 includes an attenuator 107, which outputs an attenuation signal obtained by attenuating the intensity of the transmitted amplification signal, and an acquisition unit 103, which acquires information regarding the subject 140 at least based on the output attenuation signal.

In the ultrasonic apparatus 1000 according to the present exemplary embodiments, the amplifier 132 amplifies the reception signal, and then, the transmission unit 133 transmits the amplified signal (the amplification signal). Consequently, even if an electromagnetic wave generated from the outside of the transmission unit 133 imparts noise to a signal transmitted from the transmission unit 133, the proportion of the noise generated from the outside to the transmitted signal is small. In this way, it is possible to keep the signal-to-noise ratio (SNR) of the transmitted signal high.

Meanwhile, if the intensity of the amplification signal exceeds the range (the dynamic range) of intensities of signals that can be acquired by the acquisition unit 103, the acquisition unit 103 cannot acquire the signal. To prevent such a situation like this, the attenuator 107 attenuates the intensity of the transmitted amplification signal so that the intensity of the amplification signal falls within the dynamic range of the acquisition unit 103.

With such a configuration of the ultrasonic apparatus 1000 according to the present exemplary embodiments, it is possible to acquire information about a subject based on an ultrasonic signal of which the SNR is kept high. For this reason, subject information with high accuracy is obtained.

The ultrasonic apparatus 1000 according to the present exemplary embodiments may be a photoacoustic apparatus including a light irradiation unit 111, which irradiates the subject 140 with light. The photoacoustic apparatus 1000 is configured such that the ultrasonic reception unit 131 receives the ultrasonic wave 143 generated by irradiating the subject 140 with light from the light irradiation unit 111 and outputs a reception signal.

Further, the ultrasonic apparatus 1000 according to the present exemplary embodiments may be configured such that the ultrasonic reception unit 131 can transmit the ultrasonic wave 143. Such an ultrasonic apparatus 1000 is configured such that the ultrasonic reception unit 131 receives an ultrasonic wave generated by irradiating the subject 140 with an ultrasonic wave transmitted from the ultrasonic reception unit 131 and outputs a reception signal.

A driving signal for causing the ultrasonic reception unit 131 to transmit the ultrasonic wave 143 may have a pulsed shape, and the ultrasonic apparatus 1000 may further include a pulse shaping unit (not illustrated) configured to shape the pulsed shape.

The ultrasonic wave 143 can also be referred to as an acoustic wave. Further, the ultrasonic apparatus 1000 according to the present exemplary embodiments is an apparatus for acquiring information about a subject and therefore can also be referred to as a “subject information acquisition apparatus”.

With reference to an example of the configuration illustrated in FIG. 1, the details of a subject information acquisition apparatus (an ultrasonic apparatus) according to a first exemplary embodiment are described.

### (Ultrasonic Probe)

In FIG. 1, an ultrasonic probe 130 receives an ultrasonic wave. In the present exemplary embodiment, the ultrasonic probe 130 includes an ultrasonic reception unit for receiving an ultrasonic wave and therefore can be referred to as a “reception probe” in the following description of the present exemplary embodiment. In a case where the ultrasonic probe 130 not only receives but also transmits an ultrasonic wave, the ultrasonic probe 130 can also be referred to as a “transmission/reception probe”.

A specific example of the ultrasonic probe 130 is an ultrasonic probe including an ultrasonic reception unit 131 and an amplifier 132. The position of the ultrasonic probe 130 may be changed by mechanically moving the ultrasonic probe on the subject or by a user such as a doctor or a technologist moving the ultrasonic probe relative to the subject (a handheld type). Further, as described below (a second exemplary embodiment), in the case of an ultrasonic apparatus for detecting a reflected wave generated by an ultrasonic wave being reflected from a subject, a probe for transmitting an acoustic wave may be provided separately from the ultrasonic probe 130.

### (Processing Apparatus)

A processing apparatus 100 is a main body of the subject information acquisition apparatus. In FIG. 1, the processing apparatus 100 is provided separately from the ultrasonic probe 130, but may be provided integrally with the ultrasonic probe 130.

The processing apparatus 100 includes a measurement control unit 102, which controls components included in the processing apparatus 100.

### (Light Source Unit)

A light source unit 101 emits pulsed light 112 under control of the measurement control unit 102. FIG. 1 illustrates the configuration in which the light source unit 101 is included in the processing apparatus 100. Alternatively, the light source unit 101 may be provided outside the processing apparatus 100. Specific examples of the light source unit 101 include a plurality of light-emitting elements provided in an array and a solid-state laser. Examples of a semiconductor light-emitting element include a light-emitting diode (LED) and a laser diode (LD). The light source unit 101 may be provided in the ultrasonic probe 130.

### (Light Irradiation Unit)

A light irradiation unit 111 irradiates a subject 140 with the pulsed light 112. The light irradiation unit 111 may include a lens and a mirror. Alternatively, the light irradiation unit 111 may include the light source unit 101.

### (Attenuator)

An attenuator 107 attenuates the intensity of a signal transmitted from a transmission unit 133 and outputs an attenuation signal. The attenuation factor of a signal to be attenuated by the attenuator 107 can be set to be smaller than a value obtained by dividing the maximum amplitude of an amplification signal by the maximum amplitude of a signal that can be acquired by an acquisition unit 103.

### (Acquisition Unit)

The acquisition unit 103 acquires the attenuation signal and acquires information regarding the subject 140. The acquisition unit 103 includes an arithmetic unit and a storage unit. The arithmetic unit is constituted by an arithmetic element, such as a CPU, a GPU, and an A/D converter, and an arithmetic circuit, such as an FPGA and an ASIC. The arithmetic unit does not have to be constituted by a single element and a single circuit but may be constituted by a plurality of elements and a plurality of circuits. Each of the processes according to the exemplary embodiments may be executed by any element or circuit. The storage unit is constituted by a storage medium, such as a read-only memory (ROM), a random-access memory (RAM), and a hard disk. The storage unit does not have to be constituted by a single storage medium but may be constituted by a plurality of storage media

### (Signal Processing Unit)

A signal processing unit 104 performs deconvolution and envelope detection based on a digital signal accumulated in the acquisition unit 103.

### (Image Processing Unit)

An image processing unit 105 performs image processing, using data on which signal processing has been performed by the signal processing unit 104 and relative position information calculated by a position information detection unit 123, thereby generating three-dimensional volume data. The three-dimensional volume data can be generated using an existing technique such as universal back-projection (UBP) or a Fourier transform algorithm (FTA).

### (Display Unit)

A display unit 106 presents setting information regarding the acquisition of subject information to an operator and also displays the three-dimensional volume data. The configuration may be such that the display unit 106 is of a touch panel integrated type, for example, thereby doubling as an input unit.

### (Ultrasonic Probe)

Next, the internal configuration of the ultrasonic probe 130 is described.

### (Ultrasonic Reception Unit)

An ultrasonic reception unit 131 receives an ultrasonic wave generated from the subject 140 and outputs a reception signal.

The ultrasonic reception unit 131 detects an acoustic wave 143 and converts a change in the intensity of the sound pressure of the acoustic wave 143 into an electric signal. Further, the ultrasonic reception unit 131 may include an acoustic lens by arranging acoustic wave detection elements (not illustrated) one-dimensionally or two-dimensionally. In this case, the ultrasonic reception unit 131 can detect a sound wave generated from the focal position of the acoustic lens with excellent sensitivity.

### (Amplifier)

An amplifier 132 amplifies the intensity of the reception signal and outputs an amplification signal. It is desirable to set the amplification factor of a signal to be amplified by the amplifier 132 so that the maximum amplitude of the amplification signal is greater than the maximum amplitude of a signal that can be acquired by the acquisition unit 103. As an example, the amplification factor of a signal to be amplified by the amplifier 132 can be set so that the amplification signal is 5 dB or more, 14 dB or more, 40 dB or more, or 60 dB or less.

The amplification of the reception signal by the amplifier 132 and the transmission of the amplification signal by the transmission unit 133 may be performed in the same circuit.

### (Transmission Unit)

The transmission unit 133 outputs a transmission signal from the ultrasonic probe 130. The transmission unit 133 transmits a signal between the ultrasonic probe 130 and the processing apparatus 100.

### (Subject)

Next, the internal configuration of the subject 140 is described. FIG. 1 illustrates a light absorber 141. Examples of the light absorber 141 include hemoglobin. The acoustic wave (ultrasonic wave) 143 is generated from the light absorber 141.

### (Acoustic Impedance Matching Member)

An acoustic impedance matching member 142 reduces the reflection of the acoustic wave 143 at an interface when the acoustic wave 143 generated from the light absorber 141 is transmitted to the ultrasonic reception unit 131. The acoustic impedance matching member 142 is composed of a material having the properties of transmitting the pulsed light 112, and may include a jelly-like substance as well as water.

### (Example of Configuration of Ultrasonic Reception Unit)

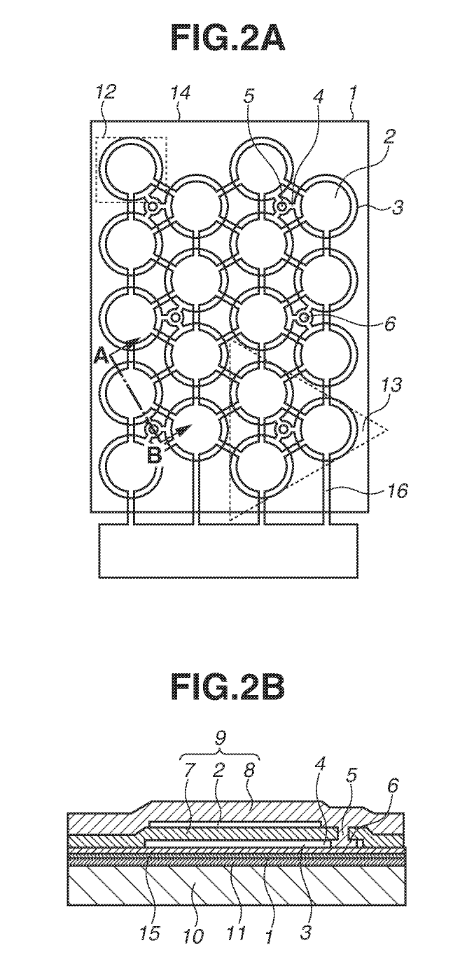

FIGS. 2A and 2B are diagrams illustrating an example of the configuration of the ultrasonic reception unit 131 according to the first exemplary embodiment of the present invention. In the present exemplary embodiment, an example is described where a capacitive transducer is used as the ultrasonic reception unit 131. The capacitive transducer includes a pair of electrodes provided with a gap therebetween and has a cell structure in which a vibrating diaphragm including one of the pair of electrodes is supported so as to vibrate.

FIG. 2A is a top view of the ultrasonic reception unit 131 according to the first exemplary embodiment of the present invention. FIG. 2B is a cross-sectional view along A-B in FIG. 2A.

The ultrasonic reception unit 131 includes a plurality of cells 12. Each cell 12 has a structure in which a vibrating diaphragm 9 including one of a pair of electrodes provided with a cavity as a gap therebetween is supported so as to vibrate. Specifically, each cell 12 includes a first electrode 1 and a vibrating diaphragm 9 including a second electrode 2 opposed to the first electrode 1 across a gap 3. The shape of the vibrating diaphragm 9 is not particularly limited, but can be a circular shape or a polygonal shape, for example. Examples of the polygonal shape include a rectangular shape and a hexagonal shape.

In FIGS. 2A and 2B, the plurality of cells 12 form a single element 14, and the capacitive transducer inputs or outputs a signal on an element-by-element basis. In other words, if each cell 12 is considered as a single capacitor, the capacitors of the plurality of cells 12 in the element 14 are electrically connected together in parallel. Further, in a case where the capacitive transducer includes a plurality of elements 14, the elements 14 are electrically separated from each other. In FIGS. 2A and 2B, each first electrode 1 is used as an electrode to which a bias voltage is applied. Each second electrode 2 is used as a signal extraction electrode. In other words, in a case where the capacitive transducer includes a plurality of elements 14, at least second electrodes 2, which function as signal extraction electrodes, need to be electrically separated from each other on an element-by-element basis. Signals (electric signals) output from the second electrodes 2 are extracted by extraction wiring 16. First electrodes 1, to which bias voltages are applied, may be electrically connected together between the plurality of elements 14, or may be separated from each other on an element-by-element basis. Further, as a matter of course, the functions of each first electrode 1 and each second electrode 2 may be reversed. In other words, the first electrode 1 on the lower side may be a signal extraction electrode, and the second electrode 2 on the vibrating diaphragm 9 side may be an electrode to which a bias voltage is applied. As wiring, through wiring may be used instead of the extraction wiring 16.

In FIGS. 2A and 2B, the vibrating diaphragm 9 includes a first membrane 7, a second membrane 8, and the second electrode 2 sandwiched between the first membrane 7 and the second membrane 8. The vibrating diaphragm 9, however, may only need to include at least the second electrode 2 and be able to vibrate. For example, the vibrating diaphragm 9 may include only the second electrode 2. Alternatively, the vibrating diaphragm 9 may include only the first membrane 7 and the second electrode 2.

In the present exemplary embodiment, the first electrode 1 is provided on a substrate 10 via a first insulating film 11, and a second insulating film 15 is provided on the first electrode 1. Alternatively, the first electrode 1 may be provided directly on the substrate 10 not via the first insulating film 11. Yet alternatively, the second insulating film 15 may not be provided on the first electrode 1 so that the first electrode 1 is exposed.

### (Capacitive Transducer)

The driving principle of the capacitive transducer is described.

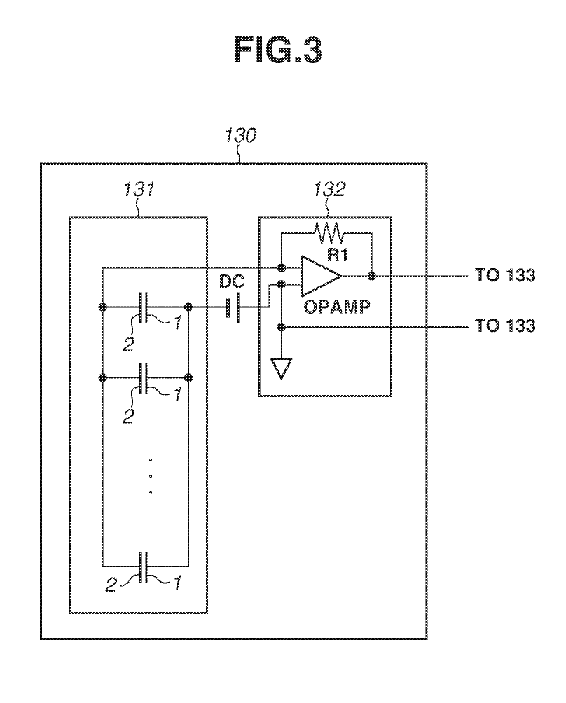

FIG. 3 is a diagram illustrating an example of the configuration of the amplifier 132 according to the first exemplary embodiment of the present invention. Components similar to those in FIGS. 1, 2A, and 2B are designated by the same numbers, and therefore are not described here.

A voltage application unit DC applies a direct current voltage between the first electrode 1 and the second electrode 2.

A reception signal of an ultrasonic wave received by the capacitive transducer is a current. For this reason, it is desirable that the amplifier 132 should include a conversion circuit (a current-voltage conversion circuit) for converting the reception signal from a current value to a voltage value and amplifying the intensity of the reception signal. In the present exemplary embodiment, an example is described where the amplifier 132 includes a transimpedance amplifier using an operational amplifier.

A feedback resistor R1 determines the amplification factor.

In FIG. 3, for ease of description, the configuration is such that the ultrasonic probe 130 includes a plurality of ultrasonic reception units 131 and a single amplifier 132 as a single set. Alternatively, a plurality of sets may be provided. The plurality of sets is arranged one-dimensionally or two-dimensionally, whereby it is possible to detect a sound wave generated from the focal position of the acoustic lens with excellent sensitivity as described above.

In a case where the capacitive transducer receives an ultrasonic wave, the voltage application unit DC applies a direct current voltage to the first electrode 1 so that a potential difference occurs between the first electrode 1 and the second electrode 2. If the capacitive transducer receives an ultrasonic wave in this state, the vibrating diaphragm 9, which includes the second electrode 2, vibrates. The vibration of the vibrating diaphragm 9 changes the distance between the second electrode 2 and the first electrode 1, and the capacitance changes. Due to this change in the capacitance, a signal (a current) is output from the second electrode 2, and the current flows through the extraction wiring 16. The transimpedance amplifier converts the current into a voltage and outputs an amplification signal. As described above, the configuration of the extraction wiring 16 may be changed, thereby applying a direct current voltage to the second electrode 2 and extracting a signal from the first electrode 1.

When passing through the transmission unit 133, the amplification signal receives electromagnetic noise from around the transmission unit 133. For this reason, the SNR of the signal deteriorates. In response, the amplifier 132 amplifies the signal, and after the signal passes through the transmission unit 133, the attenuator 107 attenuates the signal. As a specific example, the amplifier 132 amplifies the signal 10-fold, and the attenuator 107 attenuates the signal 1/10-fold. If the amplification and the attenuation are thus performed, the level of noise to be superimposed in the transmission unit 133 can be reduced to 1/10 as compared with a case where the amplification and the attenuation are not performed. Further, a signal component of an attenuation signal, which is the output of the attenuator 107, has a similar level. Therefore, the SNR of the attenuation signal can be improved 10-fold. As described above, noise to be superimposed in the transmission unit 133 is reduced, whereby it is possible to acquire highly accurate subject information. As described above, the greater the amplification factor of the amplifier 132 and the attenuation factor of the attenuator 107 are, the more reduced the level of noise to be superimposed in the transmission unit 133 can be. Further, the amplitude of the output signal of the amplifier 132 may be greater than the input amplitude of the acquisition unit 103. This is because the attenuator 107 attenuates the output signal of the amplifier 132. Thus, subsequent image processing is not affected so long as the output amplitude of the attenuator 107 falls within the input amplitude of the acquisition unit 103.

As described above, if the maximum amplitude of the output of the amplifier 132 is greater than the maximum amplitude of the input of the acquisition unit 103, it is possible to increase the effects of an improvement in the SNR. Further, in a case where the ultrasonic reception unit 131 includes the capacitive transducer, the amplification factor of the amplifier 132 can be set to 3000 V/A or more and 5000 V/A or less. Further, the signal may be amplified in the range of 30 dB or more and 60 dB or less.

Further, if the attenuation factor of the attenuator 107 is set to less than or equal to a value obtained by dividing the maximum amplitude of the output of the amplifier 132 by the maximum amplitude of the input of the acquisition unit 103, the input amplitude of the acquisition unit 103 can be optimized. In this way, a wide dynamic range is obtained.

The capacitive transducer may be used to transmit an ultrasonic wave.

To transmit an ultrasonic wave, an alternating current voltage is applied to the second electrode 2 in the state where a direct current voltage is applied to the first electrode 1, or a voltage obtained by superimposing a direct current voltage and an alternating current voltage (i.e., an alternating current voltage of which the positivity and negativity are not inverted) is applied to the second electrode 2. The vibrating diaphragm 9 is vibrated with an electrostatic force obtained by applying the alternating current voltage, and an ultrasonic wave is transmitted.

Also in a case where an ultrasonic wave is transmitted, the configuration of the extraction wiring 16 may be changed, thereby applying an alternating current voltage to the first electrode 1 and vibrating the vibrating diaphragm 9.

The capacitive transducer according to the present exemplary embodiment can perform at least one of the transmission and the reception of an ultrasonic wave (an acoustic wave).

The ultrasonic apparatus according to the present exemplary embodiment is effective particularly in an apparatus in which a reception signal is small as in a capacitive transducer. However, similar effects can be obtained also in a piezoelectric transducer. The piezoelectric transducer includes a piezoelectric element.

### (Operation Sequence)

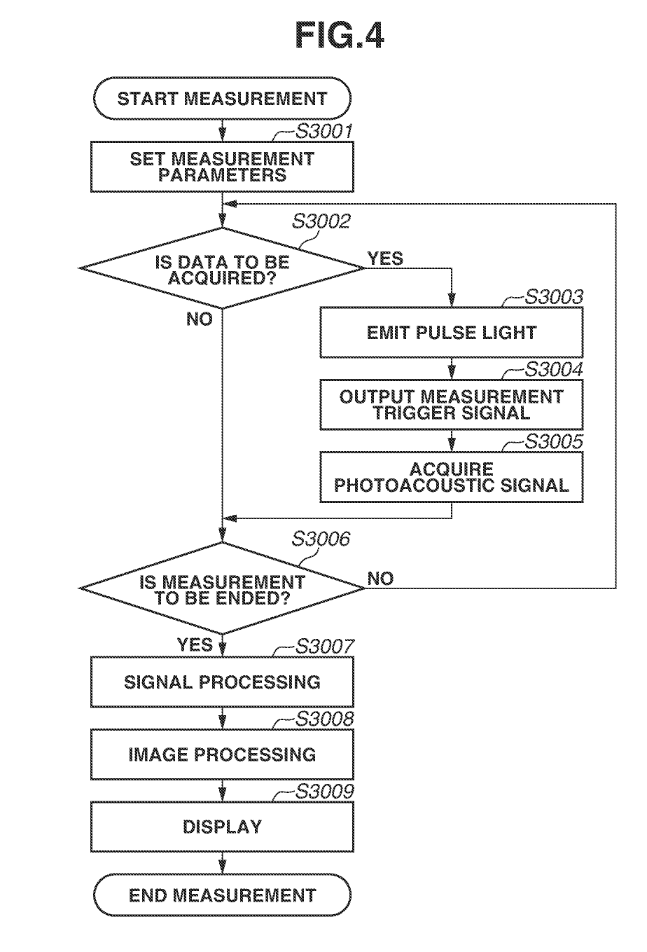

With reference to FIG. 4, an operation sequence is described. FIG. 4 illustrates an example of a measurement sequence according to the first exemplary embodiment of the present invention.

First, before subject information is acquired, the operator brings an ultrasonic probe 130 into contact with the surface of the subject 140.

In step S3001, according to an input provided by the operator through an input unit (not illustrated), the measurement control unit 102 sets measurement parameters for acquiring subject information. Specific examples of the measurement parameters include the measurement pitch of the acquisition of subject information, the saving sampling frequency of an ultrasonic signal per point, and the saving time. Other specific examples of the measurement parameters include the light emission timing, the light emission frequency, the amount of light, and the wavelength of the light source unit 101.

In step S3002, the measurement control unit 102 determines whether the acquisition of data is to be started. If the acquisition of data is not to be started (NO in step S3002), the processing proceeds to step S3006. If the acquisition of data is to be started (YES in step S3002), the processing proceeds to step S3003.

In step S3003, the light source unit 101 emits the pulsed light 112 under control of the measurement control unit 102. The pulsed light 112 passes through the light irradiation unit 111 and is incident on the subject 140. The pulsed light 112 diffused within the subject 140 is absorbed by the light absorber 141 such as blood within the subject 140. The light absorber 141 has a specific light absorption coefficient depending on its type and absorbs light to generate the acoustic wave 143.

In step S3004, the measurement control unit 102 outputs a measurement trigger signal to the acquisition unit 103.

In step S3005, the acquisition unit 103 receives the measurement trigger signal, and samples the acoustic wave 143.

The acoustic wave 143 detected by the ultrasonic reception unit 131 is converted into an electric signal, and then, the electric signal is sent to the amplifier 132. After the intensity of the signal is amplified by the amplifier 132, the signal is converted into a digital signal by the acquisition unit 103. Then, the digital signal is accumulated in an internal memory of the acquisition unit 103.

In step S3006, if the operator inputs an instruction to end the measurement through the input unit (not illustrated) (YES in step S3006), the measurement control unit 102 stops the operations of the light source unit 101 and the image capturing unit 122 and ends the measurement of the photoacoustic wave. If the operator does not input an instruction to end the measurement (NO in step S3006), the processing returns to step S3002. In step S3002, the calculation of relative position information of the ultrasonic probe 130 and the acquisition of the acoustic wave 143 are repeated until the input of an instruction to end the measurement is detected.

In step S3007, the signal processing unit 104 performs signal processing on the electric signal based on the acoustic wave 143 acquired at each measurement point, i.e., the digital signal accumulated in the acquisition unit 103. Examples of the specific content of the signal processing include deconvolution taking into account the pulse width of the light source unit 101, and envelope detection. Further, if the characteristics of the frequency of noise added to the digital signal are known, and the frequency of the noise can be separated from the main frequency of the acoustic wave 143, a particular frequency component caused by the noise may be removed by a filter process. Further, a multiple reflection component of the acoustic wave 143 reaching the ultrasonic reception unit 131 after being reflected by the surface of the subject 140 or the surface of the ultrasonic reception unit 131 may be removed from the digital signal. Further, also if the magnitude of a multiple reflection component of the acoustic wave 143 generated on the surface of the subject 140 is noticeable, the multiple reflection component may be deleted in this step.

In step S3008, the image processing unit 105 generates subject information using the signal processed by the signal processing unit 104. Specific examples of the subject information include quantitative information about a particular substance within the subject 140, a two-dimensional image, and three-dimensional volume data.

In a case where a two-dimensional image or three-dimensional volume data is generated, a known artifact, if any, may be removed from the subject information. Further, for example, blood hemoglobin may be assumed as the light absorber 141, and an optical ultrasonic wave may be measured using the pulsed light 112 of a wavelength to be mainly absorbed by blood hemoglobin. Then, three-dimensional volume data may be generated by generating an image of blood vessels. In addition to this, with a focus on a change in the optical absorption spectrum of blood hemoglobin according to its oxygenation and deoxygenation, the degree of oxygen saturation of the blood hemoglobin may be calculated from a plurality of pieces of three-dimensional volume data using the photoacoustic wave 143 generated by irradiating the blood hemoglobin with the pulsed light 112 of different wavelengths. The signal processing unit 104 and the image processing unit 105 may be configured as an integrated processing unit.

In step S3009, the three-dimensional volume data generated in step S3008 is displayed on the display unit 106 by a display method desired by the operator. For example, it is possible to use a method for displaying cross sections perpendicular to three-dimensional axes, or a method for displaying a two-dimensional distribution of maximum values, minimum values, or average values of the three-dimensional volume data with respect to the direction of each axis. Further, the operator may set a region of interest in the three-dimensional volume data, and statistical information regarding the shape of the light absorber 141 or degree-of-oxygen-saturation information in the region of interest may be displayed.

The signal processing up to the generation of the three-dimensional volume data in steps S3007 and S3008 may be performed every time a photoacoustic signal is acquired in step S3005.

As described above, noise to be superimposed in a transmission unit is reduced, whereby it is possible to acquire highly accurate subject information.

### (Information Acquisition Method)

An information acquisition method according to the present exemplary embodiment at least includes the following processes.

(1) A light irradiation process for irradiating a subject with light.
(2) A reception process for receiving an ultrasonic wave generated by irradiating the subject with the light, and for outputting a reception signal.
(3) An amplification process for amplifying an intensity of the obtained reception signal.
(4) A transmission process for transmitting an amplification signal obtained by amplifying the reception signal.
(5) An attenuation process for attenuating the transmitted amplification signal and outputting an attenuation signal.
(6) An acquisition process for acquiring information regarding the subject at least based on the obtained attenuation signal.

Alternatively, the information acquisition method may also include processes other than the above processes.

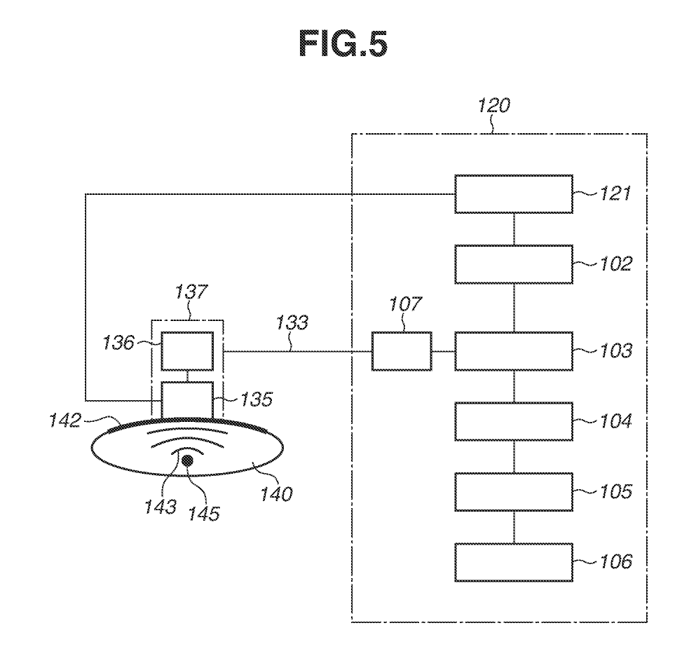

FIG. 5 illustrates a subject information acquisition apparatus, such as an ultrasonic echo diagnosis apparatus using the reflection of an acoustic wave, according to a second exemplary embodiment of the present invention.

Components similar to those in FIGS. 1, 2A, 2B, and 3 are designated by the same numbers, and therefore are not described here. A transmission/reception probe 137 transmits and receives an ultrasonic wave. An ultrasonic transmission/reception unit 135 is included in the transmission/reception probe 137. An amplification unit 136 amplifies a signal of an ultrasonic wave received by the ultrasonic transmission/reception unit 135. A driver 121 is included within an apparatus main body 120. The driver 121 drives the ultrasonic transmission/reception unit 135 to generate a pulsed ultrasonic wave from the ultrasonic transmission/reception unit 135 toward a subject 140. A reflector 145 is included in the subject 140.

An acoustic wave 143 transmitted from the ultrasonic transmission/reception unit 135 in the transmission/reception probe 137 to the subject 140 is reflected by the reflector 145. The ultrasonic transmission/reception unit 135 receives the reflected acoustic wave 143, converts the acoustic wave 143 into an electric signal, and outputs the electric signal to the amplification unit 136. The amplification unit 136 amplifies the signal and outputs the amplification signal to an attenuator 107 via a transmission unit 133. The attenuator 107 attenuates the amplification signal and outputs the attenuation signal to an acquisition unit 103. The acquisition unit 103 performs signal processing such as analog-to-digital (A/D) conversion and amplification on the input electric signal and outputs the resulting signal to a signal processing unit 104. Subsequent processing may be similar to that in the first exemplary embodiment. Further, in the case of an apparatus using a reflected wave as in FIG. 5, a probe for transmitting an acoustic wave may be provided separately from a probe for receiving an acoustic wave. Further, an apparatus having the functions of both apparatuses in FIGS. 1 and 5 may be provided and acquire both subject information reflecting the optical characteristic value of a subject and subject information reflecting the difference in acoustic impedance. In this case, the ultrasonic reception unit 131 in FIG. 1 may not only receive a photoacoustic wave, but also transmit an acoustic wave and receive a reflected wave. Also with such a configuration, it is possible to provide a subject information acquisition apparatus and a subject information acquisition method with high accuracy for reducing the influence of an electromagnetic wave radiated from a surrounding electronic device.

Based on the ultrasonic apparatus according to the present invention, it is possible to provide an ultrasonic apparatus capable of reducing the influence of an electromagnetic wave generated from the outside of a signal transmission unit and acquiring highly accurate subject information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-165124, filed Aug. 30, 2017, which is hereby incorporated by reference herein in its entirety.

What is claimed is:

1. An ultrasonic apparatus comprising:
an ultrasonic receiver configured to receive an ultrasonic wave generated from a subject and output a reception signal;
an amplifier configured to amplify an intensity of the reception signal;
a transmitter configured to transmit an amplification signal obtained by amplifying the reception signal;
an attenuator configured to output an attenuation signal obtained by attenuating an intensity of the transmitted amplification signal; and
an acquisition unit configured to acquire information regarding the subject at least based on the attenuation signal.

2. The ultrasonic apparatus according to claim 1, further comprising an ultrasonic probe including the ultrasonic receiver and the amplifier.

3. The ultrasonic apparatus according to claim 2, wherein the ultrasonic probe is a handheld ultrasonic probe.

4. The ultrasonic apparatus according to claim 2, further comprising a processing apparatus that is provided separately from the ultrasonic probe and includes the attenuator and the acquisition unit.

5. The ultrasonic apparatus according to claim 1, wherein the amplification of the reception signal by the amplification unit and the transmission of the amplification signal by the transmission unit are performed in a same circuit.

6. The ultrasonic apparatus according to claim 1, further comprising a light irradiation unit configured to irradiate the subject with light,
wherein the ultrasonic receiver unit receives an ultrasonic wave generated by irradiating the subject with the light from the light irradiation unit and outputs a reception signal.

7. The ultrasonic apparatus according to claim 6, wherein the light irradiation unit includes a light source configured to generate the light with which the subject is to be irradiated.

8. The ultrasonic apparatus according to claim 7, wherein the light source includes a plurality of light-emitting elements provided in an array.

9. The ultrasonic apparatus according to claim 7, wherein the light source includes a solid-state laser.

10. The ultrasonic apparatus according to claim 1, wherein the ultrasonic receiver is capable of transmitting an ultrasonic wave, and the ultrasonic reception unit receives an ultrasonic wave generated by irradiating the subject with an ultrasonic wave transmitted from the ultrasonic receiver and outputs a reception signal.

11. The ultrasonic apparatus according to claim 10, wherein a driving signal for causing the ultrasonic receiver to transmit an ultrasonic wave has a pulsed shape, and the ultrasonic apparatus further comprises a pulse shaping unit configured to shape the pulsed shape.

12. The ultrasonic apparatus according to claim 1, wherein an amplification factor of a signal to be amplified by the amplifier is set so that a maximum amplitude of the amplification signal is greater than a maximum amplitude of a signal that is acquirable by the acquisition unit.

13. The ultrasonic apparatus according to claim 1, wherein an amplification factor of a signal to be amplified by the amplifier is set so that the amplification signal is 14 dB or more.

14. The ultrasonic apparatus according to claim 1, wherein an amplification factor of a signal to be amplified by the amplifier is set so that the amplification signal is 40 dB or more.

15. The ultrasonic apparatus according to claim 1, wherein an amplification factor of a signal to be amplified by the amplifier is set so that the amplification signal is 60 dB or less.

16. The ultrasonic apparatus according to claim 1, wherein an attenuation factor of a signal to be attenuated by the attenuator is set to be smaller than a value obtained by dividing a maximum amplitude of the amplification signal by a maximum amplitude of a signal that is acquirable by the acquisition unit.

17. The ultrasonic apparatus according to claim 1, wherein the ultrasonic receiver includes a piezoelectric transducer.

18. The ultrasonic apparatus according to claim 1, wherein the ultrasonic receiver includes a capacitive transducer.

19. The ultrasonic apparatus according to claim 18, wherein the capacitive transducer includes a pair of electrodes provided with a gap therebetween and has a cell structure in which a vibrating diaphragm including one of the pair of electrodes is supported so as to vibrate.

20. The ultrasonic apparatus according to claim 19, wherein the vibrating diaphragm has a circular shape or a polygonal shape.

21. The ultrasonic apparatus according to claim 19, wherein the vibrating diaphragm has a rectangular shape.

22. The ultrasonic apparatus according to claim 18, wherein the amplifier includes a conversion circuit configured to convert the reception signal from a current value to a voltage value and amplify the intensity of the reception signal.

23. The ultrasonic apparatus according to claim 22, wherein an amplification factor of the amplifier is set to 3000 V/A or more and 5000 V/A or less.

24. An information acquisition method comprising:
irradiating a subject with light;
receiving an ultrasonic wave generated by irradiating the subject with the light, and outputting a reception signal;
amplifying an intensity of the reception signal;
transmitting an amplification signal obtained by amplifying the reception signal;
attenuating the transmitted amplification signal and outputting an attenuation signal; and
acquiring information regarding the subject at least based on the attenuation signal.
